(19) United States
(12) Patent Application Publication
(10) Pub. No.: US 2006/0294159 A1
(43) Pub. Date: Dec. 28, 2006

(54) Method and process for co-existing versions of standards in an abstract and physical data environment

(75) Inventors: Richard D. Dettinger, Rochester, MN (US); Judy I. Djugash, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: International Business Machines Corporation, Armonk, NY (US)

(21) Appl. No.: 11/165,386

(22) Filed: Jun. 23, 2005

(51) Int. Cl. G06F 17/30

(52) U.S. Cl. 707/203

(57) ABSTRACT

Embodiments of the invention provide methods, apparatus, and articles of manufacture for managing different versions of a data model standard in both abstract and physical database environments. In one embodiment, new versions of the data model standard are analyzed to identify changes introduced by the new version. The database schema, organized according to the initial version of the standard, is then modified to reflect these changes. Logical representations of the data are provided that expose data organized according to both the initial version of the standard and according to the subsequent version of the standard.

### BACKGROUND OF THE INVENTION

1. Field of the Invention

The present invention generally relates to database query applications. More specifically, the present invention relates to processing data shared or exchanged using both an initial version and a subsequent version of a data markup standard.

2. Description of the Related Art

Data may be represented using many different formats and markup languages. One such markup language that has enjoyed widespread use in recent years is extensible markup language (XML). As those skilled in the art will recognize, XML is a general-purpose markup language used for creating special-purpose markup languages, and is used to describe many different types of data. Its primary use has been to exchange and share data across different systems, particularly systems connected via the Internet.

Because XML is a general purpose language, people and organizations that wish to share data often agree to a standard representation format for the data. This is often the case in scientific endeavors where researchers wish to operate using a common representation of data, and many standards exist for using XML to describe particular types of data. For example, MageML 1.0 or Microarray Gene Expression Markup Language is an XML standard designed for describing and exchanging information about microarray experiments. MageML is based on XML and can describe microarray designs, microarray experiment setups, gene expression data, and data analysis results. The MageML standard defines the allowed, required, and optional XML tags, attributes and characteristics of a valid MageML document.

Very often, after a standard is adopted, situations arise where the standard needs to evolve or grow. For example, work is currently underway on a MageML 2.0 standard. At the same time, however, standards bodies rarely remove elements from a standard, especially where a standard has gained any level of widespread use or acceptance. Such drastic measures are rarely taken by groups promoting interoperability and standardization. Doing so “breaks” the standard for users that rely on the removed elements. Thus, although elements may be deprecated, they are generally not removed.

Although XML is useful for describing and exchanging data, it is not ideal for the storing or querying of data. Thus, users often define a database schema (e.g., a set of tables, columns and keys) to store data represented using a standard format (e.g., a MageML document). Data marked up according to the standard may then be “shredded” to retrieve the data captured in a markup document and store it in the database. “Shredding” is a commonly used term to describe the process of parsing the data described by an XML document and storing it in a database.

Providing a new version that extends or enhances an existing standard, however, presents challenges for managing a database configured to store data shredded from documents based on the prior version. If a new version of the standard is adopted, a database administrator faces a choice, either update the database to reflect the new standard, or discard data received in markup documents that is incompatible with the prior version. Because new versions of a standard typically extend what information may be represented using the standard, this approach is far from ideal.

Upgrading to the new version, however, presents challenges as well. For example, a great deal of data may still exist in the prior version, and some entities may choose to continue to store and exchange data using the prior version. Thus, there may be a strong incentive to continue to offer a database based on the prior version. In some cases, this has led to database administrators maintaining separate databases for each version of the standard, an inefficient and costly approach, especially where substantial portions of the data stored by the two databases is redundant of one another.

Accordingly, there remains a need for improved techniques for managing data represented using standardized markup languages to account for different incremental versions of the standard.

### SUMMARY OF THE INVENTION

Embodiments of the invention provide a method, apparatus, and article of manufacture for managing data stored using multiple, co-existing versions of a data markup standard using an abstract database environment.

One embodiment provides a computer-implemented method of managing access to data stored in a database, wherein the database is organized according to an initial version of a data model standard. The method generally includes, comparing a subsequent version of the standard with the initial version of the standard, modifying a schema of the database to reflect changes identified by the comparison, and defining a first logical representation that exposes the data organized according to the initial version of the standard and a second logical representation that exposes data organized according to the subsequent version of the standard.

Another embodiment of the invention provides a method for accessing data represented using multiple versions of a data model standard. The method generally includes, providing a relational database schema, with tables and columns available to store data organized according to both an initial version of the standard and a subsequent version of the standard, and creating a first and a second database view, each exposing a collection of tables and columns of the database schema corresponding to the initial version and subsequent versions of the standard, respectively. The method generally further includes defining a first and a second database abstraction model each database abstraction model defining a plurality of logical field definitions, each logical field definition comprising a logical field name and a reference to an access method selected from at least two different access method types; wherein each of the different access methods types defines a mapping from the logical field to one of the database views.

Another embodiment provides a system for managing data organized according to at least two different versions of a data model standard. The system generally includes a computer database with tables and columns available to store data organized according to both an initial version of the standard and a subsequent version of the standard, a first and second database view, each exposing a collection of tables and columns of a database schema corresponding to the initial version and subsequent versions of the standard, respectively, and a first and a second database abstraction model each database abstraction model defining a plurality of logical field definitions, each logical field definition comprising a logical field name and a reference to an access method selected from at least two different access method types; wherein each of the different access methods types defines a mapping from the logical field to one of the database views; and wherein the first and second database abstraction models allow users to compose queries via a query interface.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments illustrated by the appended drawings. These drawings, however, illustrate only typical embodiments of the invention and are not limiting of its scope, for the invention may admit to other equally effective embodiments.

FIG. 1 illustrates an exemplary computing and data communications environment, according to one embodiment of the invention.

FIG. 2A illustrates a logical view of the database abstraction model configured to access data stored in an underlying physical database, according to one embodiment of the invention.

FIG. 2B further illustrates a database abstraction model, according to one embodiment of the invention.

FIG. 3A illustrates a functional block diagram of components used to populate a database with data represented using an initial version of a standard (FIG. 3A) and a subsequent version of the standard (FIG. 3B), according to one embodiment of the invention.

FIGS. 4A-4B are functional block diagrams illustrating a set of internal database tables, accessed using one or more database views, according to one embodiment of the invention.

FIG. 5 is a flow chart illustrating a method for configuring a database to store data according to an initial version of a standard, according to one embodiment of the invention.

FIG. 6 is a flow chart illustrating a method for updating the database to manage data stored using multiple, co-existing versions of a data markup standard, according to one embodiment of the invention.

FIG. 7 is a flow chart illustrating a method for building a database abstraction model configured to query, search and retrieve data stored using multiple, co-existing versions of a data markup standard, according to one embodiment of the invention.

FIG. 8 illustrates an exemplary graphical user interface component that allows a user to select between different versions of a standard when composing or executing a database query, according to one embodiment of the invention.

### DETAILED DESCRIPTION OF THE PREFERRED EMBODIMENTS

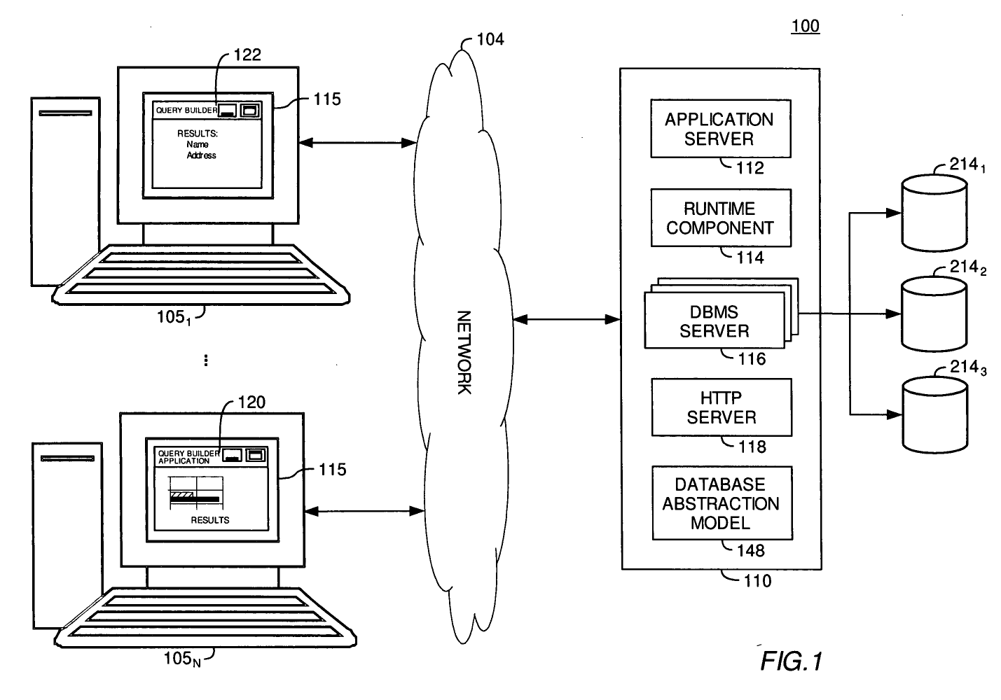

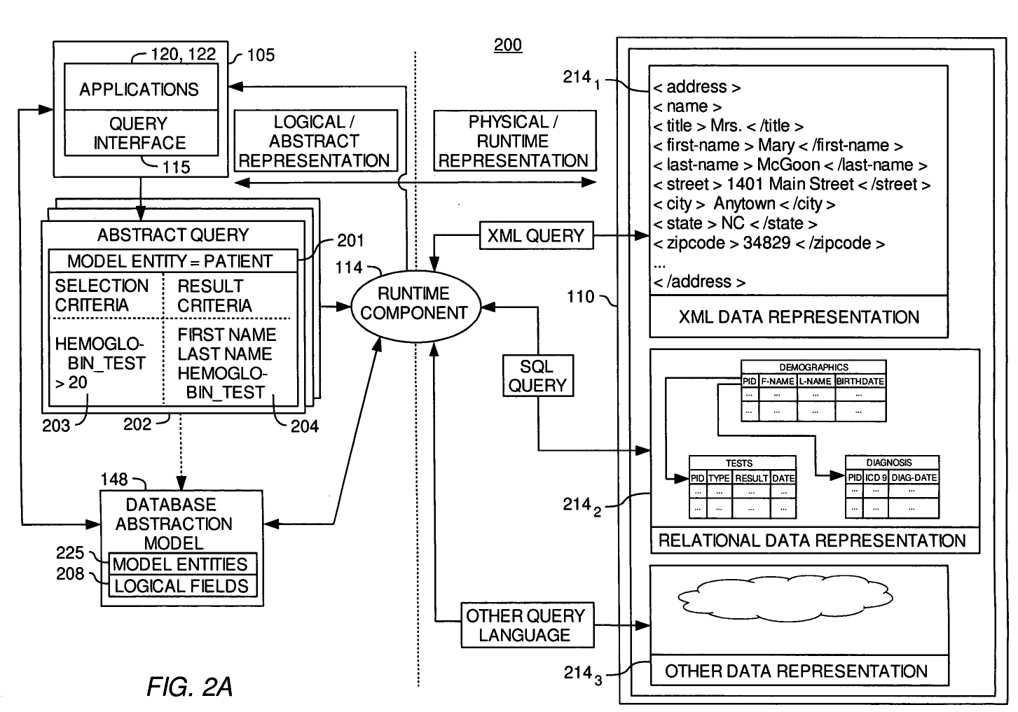

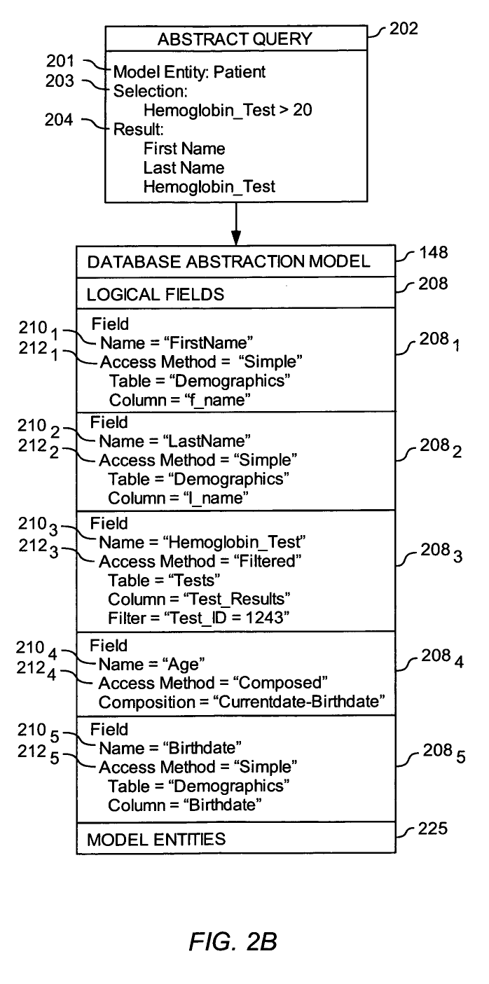

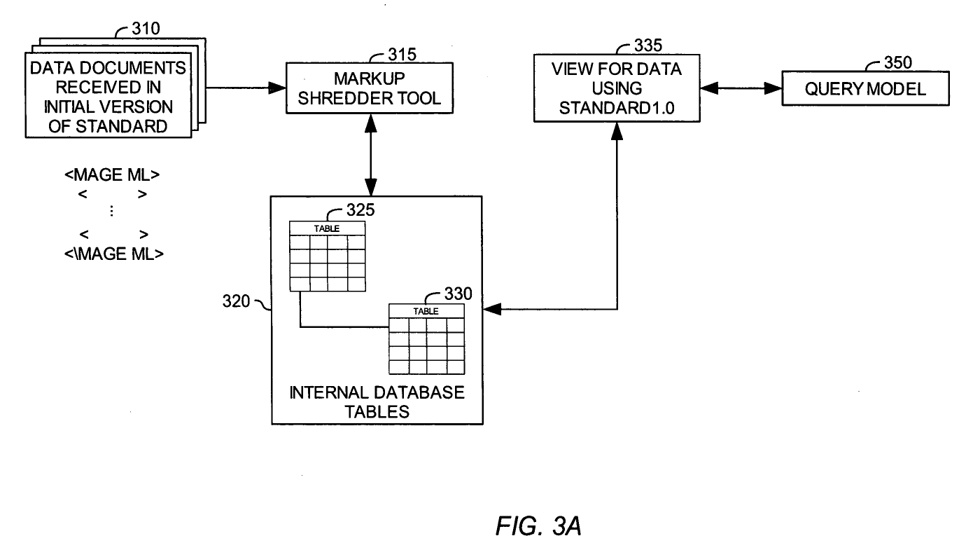

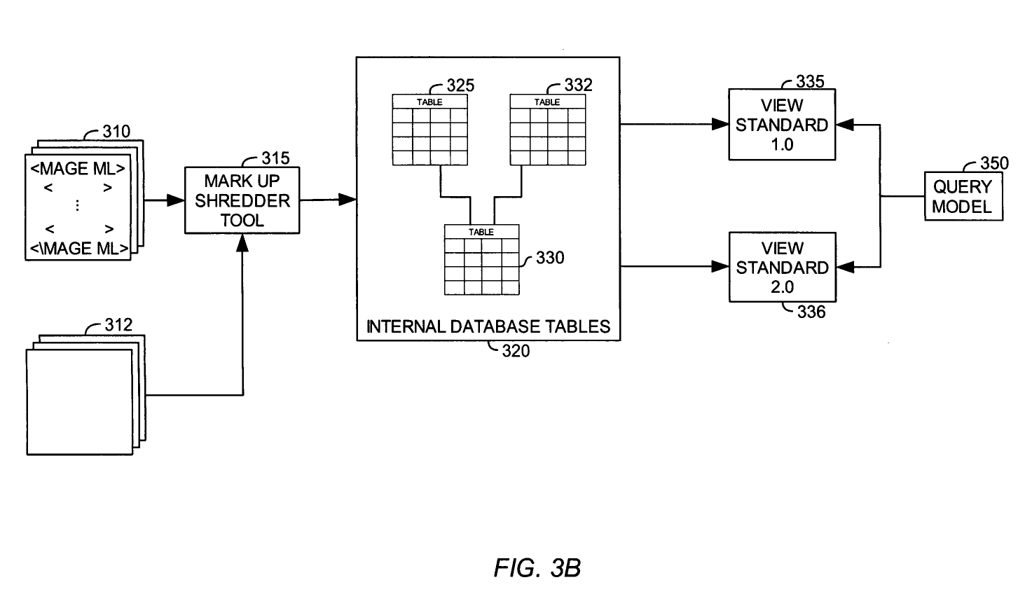

The present invention provides methods, systems, and articles of manufacture for creating a database to stores data formatted and exchanged using multiple, co-existing versions of a markup standard, (e.g., MageML, other XML standard). Additionally, embodiments of the invention may be implemented using a database abstraction model and physical query model that rely on a single underlying data storage mechanism, such as a relational database. Typically, one query model is made available for each version of a data standard. FIGS. 1-2 provide a description of the database abstraction model environment. Using this environment, FIGS. 3-7 illustrate embodiments of the invention used to provide a query model for co-existing versions of data stored according to different versions of an open standard (e.g., the MageML standard). As used herein the term “standard” refers to a representation of data based on an agreed upon format. Often, the data is represented using a markup language like MageML, but may also include a representation of the data stored in the tables and columns of a database, wherein the schema for the tables and columns is derived from the standard.

It should be noted, however, that although the following description uses the MageML standard as an example, other open XML standards, or other markup languages may be used to implement embodiments of the invention. Further, embodiments of the invention may be implemented using non-open standards within a single organization. For example, when new information is added to an existing data-exchange or storage format, and where a current data exchange or data storage representation is not modified, embodiments of the invention may be used to provide a corresponding query model for both the initial and subsequent versions of the standard.

The following description references embodiments of the invention. The invention, however, is not limited to any specifically described embodiment; rather, any combination of the following features and elements, whether related to a described embodiment or not, implements and practices the invention. Moreover, in various embodiments the invention provides numerous advantages over the prior art. Although embodiments of the invention may achieve advantages over other possible solutions and the prior art, whether a particular advantage is achieved by a given embodiment does not limit the scope of the invention. Thus, the following aspects, features, embodiments and advantages are illustrative of the invention and are not considered elements or limitations of the appended claims; except where explicitly recited in a claim. Similarly, references to “the invention” should neither be construed as a generalization of any inventive subject matter disclosed herein nor considered an element or limitation of the appended claims; except where explicitly recited in a claim.

One embodiment of the invention is implemented as a program product for use with a computer system such as, for example, the computer system 100 shown in FIG. 1 and described below. The program product defines functions of the embodiments (including the methods) described herein and can be contained on a variety of signal-bearing media. Illustrative signal-bearing media include, without limitation, (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed across communications media, (e.g., a computer or telephone network) including wireless communications. The latter embodiment specifically includes information shared over the Internet or other computer networks. Such signal-bearing media, when carrying computer-readable instructions that perform methods of the invention, represent embodiments of the present invention.

In general, software routines implementing embodiments of the invention may be part of an operating system or part of a specific application, component, program, module, object, or sequence of instructions such as an executable script. Such software routines typically comprise a plurality of instructions capable of being performed using a computer system. Also, programs typically include variables and data structures that reside in memory or on storage devices as part of their operation. In addition, various programs described herein may be identified based upon the application for which they are implemented. Those skilled in the art recognize, however, that any particular nomenclature or specific application that follows facilitates a description of the invention and does not limit the invention for use solely with a specific application or nomenclature. Furthermore, the functionality of programs described herein using discrete modules or components interacting with one another. Those skilled in the art recognize, however, that different embodiments may combine or merge such components and modules in many different ways.

Moreover, examples described herein reference medical research environments. These examples are provided to illustrate embodiments of the invention, as applied to one type of data environment. The techniques of this invention, however, are contemplated for any data environment including, for example, transactional environments, financial environments, research environments, accounting environments, legal environments, and the like.

FIG. 1 illustrates a networked computer system using a client-server configuration. Client computer systems 105_{1-N} include an interface that enables network communications with other systems over network 104. The network 104 may be a local area network where both the client system 105 and server system 110 reside in the same general location, or may be network connections between geographically distributed systems, including network connections over the Internet. Client system 105 generally includes a central processing unit (CPU) connected by a bus to memory and storage (not shown). Each client system 105 is typically running an operating system configured to manage interaction between the computer hardware and the higher-level software applications running on client system 105 (e.g., a Linux® distribution, Microsoft Windows®, IBM's AIX® or OS/400®, FreeBSD, and the like). (“Linux” is a registered trademark of Linus Torvalds in the United States and other countries.)

The server system 110 may include hardware components similar to those used by client system 105. Accordingly, the server system 110 generally includes a CPU, a memory, and a storage device, coupled by a bus (not shown). The server system 110 is also running an operating system.

The environment 100 illustrated in FIG. 1, however, is merely an example of one hardware and software environment. Embodiments of the present invention may be implemented using other configurations, regardless of whether the computer systems are complex multi-user computing systems, such as a cluster of individual computers connected by a high-speed network, single-user workstations, or network appliances lacking non-volatile storage. Additionally, although FIG. 1 illustrates computer systems organized using a client and server architecture, embodiments of the invention may be implemented in a single computer system, or in other configurations, including peer-to-peer, distributed, or grid architectures.

In one embodiment, users interact with the server system 110 using a graphical user interface (GUI) provided by interface 115. In a particular embodiment, GUI content may comprise HTML documents (i.e., web-pages) rendered on a client computer system 105, using web-browser 122. In such an embodiment, the server system 110 includes a Hypertext Transfer Protocol (HTTP) server 118 (e.g., a web server such as the open source Apache web-sever program or IBM's Web Sphere® program) configured to respond to HTTP requests from the client system 105 and to transmit HTML documents to client system 105. The web-pages themselves may be static documents stored on server system 110 or generated dynamically using application server 112 interacting with web-server 118 to service HTTP requests. Alternatively, client application 120 may comprise a database front-end, or query application program running on client system 105_{N}. The web-browser 122 and the application 120 may be configured to allow a user to compose an abstract query, and to submit the query to the runtime component 114.

As illustrated in FIG. 1, server system 110 may further include runtime component 114, DBMS server 116, and database abstraction model 148. In one embodiment, these components may be provided using software applications executing on the server system 110. The DBMS server 116 includes a software application configured to manage databases 214₁₋₃. That is, the DBMS server 116 communicates with the underlying physical database system, and manages the physical database environment behind the database abstraction model 148. Users interact with the query interface 115 to compose and submit an abstract query to the runtime component 114 for processing. In turn, the runtime component 114 receives an abstract query and, in response, generates a resolved query of underlying physical databases 214.

In one embodiment, the runtime component may be configured to generate a physical query (e.g., an SQL statement) from an abstract query. Typically, users may compose an abstract query using the logical fields defined by the database abstraction model 148. And the runtime component 114 may be configured to use the access method defined for a logical field 208 to generate a query of the underlying physical database (referred to as a “resolved” or “physical” query). Logical fields and access methods are described in greater detail below in reference to FIGS. 2A-2B. Additionally, the runtime component 114 may also be configured to return query results to the requesting entity, (e.g., using HTTP server 118, or equivalent).

The Database Abstraction Model: Logical View of the Environment

FIG. 2A illustrates a plurality of interrelated components of the invention, along with relationships between the logical view of data provided by the database abstraction model environment (the left side of FIG. 2A), and the underlying physical database environment used to store the data (the right side of FIG. 2A).

In one embodiment, the database abstraction model 148 provides definitions for a set of logical fields 208 and model entities 225. Users compose an abstract query 202 by specifying logical fields 208 to include in selection criteria 203 and results criteria 204. An abstract query 202 may also identify a model entity 201 from the set of model entities 225. The resulting query is generally referred to herein as an “abstract query” because it is composed using logical fields 208 rather than direct references to data structures in the underlying physical databases 214. The model entity 225 may be used to indicate the focus of the abstract query 202 (e.g., a “patient,” or a “bioassay,” and the like).

For example, abstract query 202 specifies that it is a query of the “patient” model entity 201, and further includes selection criteria 203 indicating that patients with a “hemoglobin_test>20” should be retrieved. The selection criteria 203 are composed by specifying a condition evaluated against the data values corresponding to a logical field 208 (in this case the “hemoglobin_test” logical field. The operators in a condition typically include comparison operators such as =, >, <, >=, or, <=, and logical operators such as AND, OR, and NOT. Results criteria 204 indicates that data retrieved for this abstract query 202 includes data for the “name,” “age,” and “hemoglobin_test” logical fields 208.

In one embodiment, users compose an abstract query 202 using query building interface 115. The interface 115 may be configured to allow users to compose an abstract query 202 from the logical fields 208 defined by the database abstraction model 148. The definition for each logical field 208 in the database abstraction model 148 specifies an access method identifying the location of data in the underlying physical database 214. In other words, the access method defined for a logical field provides a mapping between the logical view of data exposed to a user interacting with the interface 115 and the physical view of data used by the runtime component 114 to retrieve data from the physical databases 214.

Additionally, the database abstraction model 148 may define a set of model entities 225 that may be used as the focus for an abstract query 202. In one embodiment, users select which model entity to query as part of the query composition process. Model entities are descried below, and further described in commonly assigned, co-pending application Ser. No. 10/403,356, filed Mar. 31, 2003, entitled “Dealing with Composite Data through Data Model Entities,” incorporated herein by reference in its entirety.

In one embodiment, the runtime component 114 retrieves data from the physical database 214 by generating a resolved query (e.g., an SQL statement) from the abstract query 202. Because the database abstraction model 148 is not tied to either the schema of the physical database 214 or the syntax of a particular query language, additional capabilities may be provided by the database abstraction model 148 without having to modify the underlying database. Further, depending on the access method specified for a logical field, the runtime component 114 may transform abstract query 202 into an XML query that queries data from database 214₁, an SQL query of relational database 214₂, or other query composed according to another physical storage mechanism using other data representation 214₃, or combinations thereof (whether currently known or later developed).

FIG. 2B illustrates an exemplary abstract query 202, relative to the database abstraction model 148, according to one embodiment of the invention. The query includes selection criteria 203 indicating that the query should retrieve instances of the patient model entity 201 with a “hemoglobin” test value greater than “20.” The particular information retrieved using abstract query 202 is specified by result criteria 204. In this example, the abstract query 202 retrieves a patient's name and a test result value for a hemoglobin test. The actual data retrieved may include data from multiple tests. That is, the query results may exhibit a one-to-many relationship between a particular model entity and the query results

An illustrative abstract query corresponding to abstract query 202 is shown in Table I below. In this example, the abstract query 202 is represented using XML. In one embodiment, application 115 may be configured to generate an XML document to represent an abstract query composed by a user interacting with the query building interface 115.

TABLE I
Query Example

001 <?xml version=“1.0”?>
002 <!--Query string representation: (“Hemoglobin_test > 20”)
003 <QueryAbstraction>
004 <Selection>
005 <Condition>
006 <Condition field=“Hemoglobin Test” operator=“GT”
value=“20”
007 </Condition>
008 </Selection>
009 <Results>
010 <Field name=“FirstName”/>
011 <Field name=“LastName”/>
012 <Field name=“hemoglobin_test”/>
013 </Results>
014 <Entity name=“patient” >
015 <FieldRef name=“data://patient/PID” />
016 <Usage type=“query” />
017 </EntityField>
018 </Entity>
019 </QueryAbstraction>

The XML markup shown in Table I includes the selection criteria 203 (lines 004-008) and the results criteria 204 (lines 009-013). Selection criteria 203 includes a field name (for a logical field), a comparison operator (=, >, <, etc) and a value expression (what the field is being compared to). In one embodiment, the results criteria 204 include a set of logical fields for which data should be returned. The actual data returned is consistent with the selection criteria 203. Line 13 identifies the model entity selected by a user, in this example, a “patient” model entity. Thus, the query results returned for abstract query 202 are instances of the “patient” model entity. Line 15 indicates the identifier in the physical database 214 used to identify instances of the model entity. In this case, instances of the “patient” model entity are identified using values from the “Patient ID” column of a patient table.

After composing an abstract query, a user may provide it to runtime component 114 for processing. In one embodiment, the runtime component 114 may be configured to process the abstract query 202 by generating an intermediate representation of the abstract query 202, such as an abstract query plan. In one embodiment, an abstract query plan is composed from a combination of abstract elements from the data abstraction model and physical elements relating to the underlying physical database. For example, in one embodiment an abstract query plan may identify the relational tables and columns are referenced by logical fields included in the abstract query, and further identify how to join retrieved data together. The runtime component 114 may then parse the intermediate representation in order to generate a physical query of the underlying database. Techniques for generating the physical query are further described in commonly assigned U.S. patent application Ser. No. 10/083,075 entitled “Application Portability and Extensibility through Database Schema and Query Abstraction,” discloses techniques for constructing a database abstraction model over an underlying physical database. Abstract query plans and query processing are further described in commonly assigned, co-pending U.S. patent application Ser. No. 11/005,418 entitled “Abstract Query Plan.” The relevant teachings of these applications are incorporated by reference herein in their entirety.

FIG. 2B further illustrates an embodiment of a database abstraction model 148 that includes a plurality of logical field specifications 208_{1-5 (five shown by way of example). The access methods included in logical field specifications 208 (or logical field, for short) are used to map the logical fields 208 to tables and columns in an underlying relational database (e.g., database 214}₂ shown in FIG. 2A). As illustrated, each field specification 208 identifies a logical field name 210₁₋₅ and an associated access method 212₁₋₅. Depending upon the different types of logical fields, any number of access methods may be supported by the database abstraction model 148. FIG. 2B illustrates access methods for simple fields, filtered fields, and composed fields. Each of these three access methods are described below.

A simple access method specifies a direct mapping to a particular entity in the underlying physical database. Field specifications 208₁, 208₂, and 208₅ each provide a simple access method, 212₁, 212₂, and 212₅, respectively. For a relational database, the simple access method maps a logical field to a specific database table and column. For example, the simple field access method 212, shown in FIG. 2B maps the logical field name 210, “FirstName” to a column named “f_name” in a table named “Demographics.”

Logical field specification 208₃ exemplifies a filtered field access method 212₃. Filtered access methods identify an associated physical database and provide rules defining a particular subset of items within the underlying database that should be returned for the filtered field. Consider, for example, a relational table storing test results for a plurality of different medical tests. Logical fields corresponding to each different test may be defined, and a filter for each different test is used to associate a specific test with a logical field. For example, logical field 208₃ illustrates a hypothetical “hemoglobin test.” The access method for this filtered field 2123 maps to the “Test_Result” column of a “Tests” tests table and defines a filter “Test_ID=‘1243.’” Only data that satisfies the filter is returned for this logical field. Accordingly, the filtered field 208₃ returns a subset of data from a larger set, without the user having to know the specifics of how the data is represented in the underlying physical database, or having to specify the selection criteria as part of the query building process.

Field specification 208₄ exemplifies a composed access method 212₄. Composed access methods generate a return value by retrieving data from the underlying physical database and performing operations on the data. In this way, information that does not directly exist in the underlying data representation may be computed and provided to a requesting entity. For example, logical field access method 212₄ illustrates a composed access method that maps the logical field “age” 208₄ to another logical field 208₅ named “birthdate.” In turn, the logical field “birthdate” 208₅ maps to a column in a demographics table of relational database 214₂. In this example, data for the “age” logical field 208₄ is computed by retrieving data from the underlying database using the “birthdate” logical field 208₅, and subtracting a current date value from the birth date value to calculate an age value returned for the logical field 2084. Another example includes a “name” logical filed (not shown) composed from the first name and last name logical fields 208, and 2082.

By way of example, the field specifications 208 shown in FIG. 2B are representative of logical fields mapped to data represented in the relational data representation 2142. However, other instances of the data repository abstraction component 148 or, other logical field specifications, may map to other physical data representations (e.g., databases 214₁ or 214₃ illustrated in FIG. 2A). Further, in one embodiment, the database abstraction model 148 is stored on computer system 110 using an XML document that describes the model entities, logical fields, access methods, and additional metadata that, collectively, define the database abstraction model 148 for a particular physical database system. Other storage mechanisms or markup languages, however, are also contemplated.

The Database Abstraction Model: Co-Existing Versions of Data Model Standards

FIG. 3A illustrates a functional block diagram of components used to populate a database with data represented using an initial version of a markup language standard, according to one embodiment of the invention. As illustrated, the components include markup language data documents 310 (e.g., a plurality of MageML documents), a markup document shredder tool, 315, database tables 320, database view 335, query interface 115.

In one embodiment, the database tables 320 store data shredded from markup documents 310. The schema (i.e., the tables, columns, and keys) for database tables 320 may be generated, for example, using known tools configured to parse and analyze a markup language, or from a manual analysis of the structure of the markup language. The database tables 320 provide representation of the data that allows users to store, search, and query data, organized according to the standard. Data documents 310 include data represented using the relevant markup language; thus, documents 310 may include documents composed using, e.g., the MageML markup language (or other standard). The markup shredder tool 315 is an application that receives, as input, data documents 310. The shredder tool is configured to remove all of the structured information provided by the markup language, and store the data from documents 310 in database tables 320. That is, it strips all of the markup elements such as tags, attributes, and any other metadata from data documents 310, and stores the remaining substantive data in the appropriate columns of database tables 320. In either form, the data is organized according to the standard using, first, the standard markup language, and second, the columns of database tables 320. As illustrated, data from data documents 310 is stored in tables 325 and 330.

Once a set of database tables 320 is defined, database view 335 is used to expose a view of the data stored therein. The view is configured to expose the underlying data, as represented using the initial version of the standard. As those skilled in the art will recognize, a database view is a collection of database tables created using the result set of a pre-compiled query. Unlike individual tables 325 and 330, view 335 is not part of the schema of database tables 320; rather, it is a dynamic table computed or collated from data the physical database tables 320.

Query interface 115 provides users a mechanism for users to query, search, and retrieve data from database 320, through view 335. For example, the query model 350 may be a database abstraction model 148, as described above with reference to FIGS. 1 and 2. Thus, a collection of logical fields may be defined to map to the columns of database view 335, and query interface 115 may provide users a mechanism for composing queries. Alternatively, query model 350 may include an SQL query composition tool allowing users to compose and execute SQL queries against view 335 directly.

FIG. 3B illustrates the environment first illustrated in FIG. 3A after a subsequent version of the standard is introduced. In addition to the elements of FIG. 3A, FIG. 3B includes data documents 312, new database table 332, and database view 336. Data documents 312 may include data represented using the subsequent version of the standard. In one embodiment, after a new version of a data model standard is introduced (e.g., MageML 2.0), the database tables 320 are modified to incorporate additions or enhancements to the standard. This may involve both adding new tables to database tables 320, and/or may involve adding additional columns to existing tables. For example, in FIG. 3B, database tables 320 includes the additional table 332. Table 332 represents a modification to the database 320 to incorporate new additions or enhancements made to the standard.

In addition to the database view created for the initial version of the standard (view 335), database view 336 is provided to expose data from the database tables 320 according to the subsequent version of the standard. Query model 350 may also be updated. For example, using database abstraction techniques, query model 350 may provide database abstraction model 148₂ that includes logical fields that map to columns of the view 336. In one embodiment, this may include all of the logical fields that map to columns of view 335, along with additional logical fields 208 mapping to the columns and tables added to the database tables 320 to account for additions and enhancements to the standard. By creating multiple database abstraction models (e.g., models 148₁ and 148₂), users may query, search and retrieve data organized according to different versions of the standard.

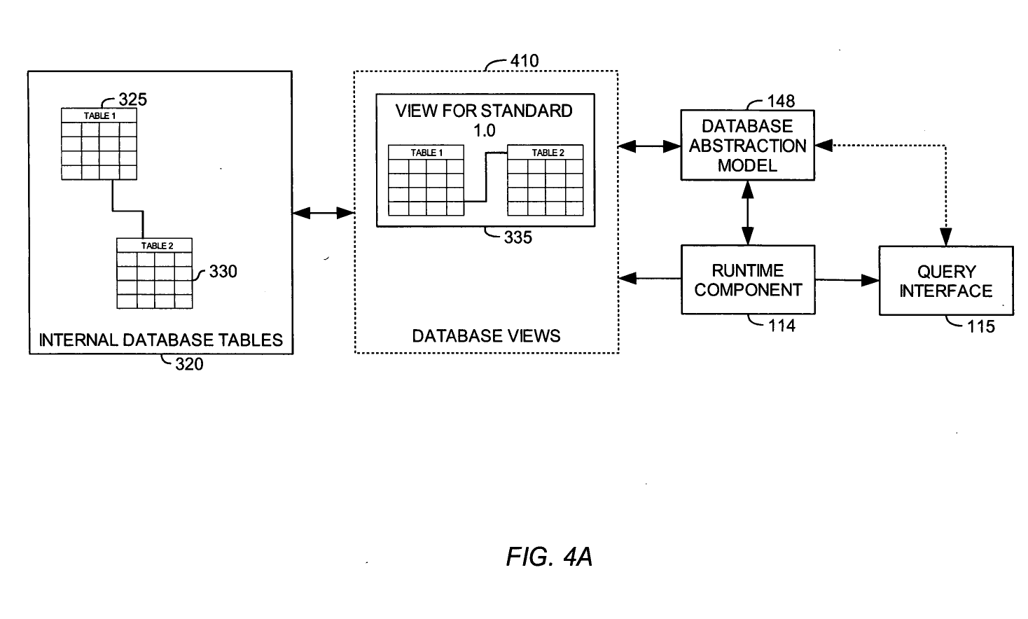

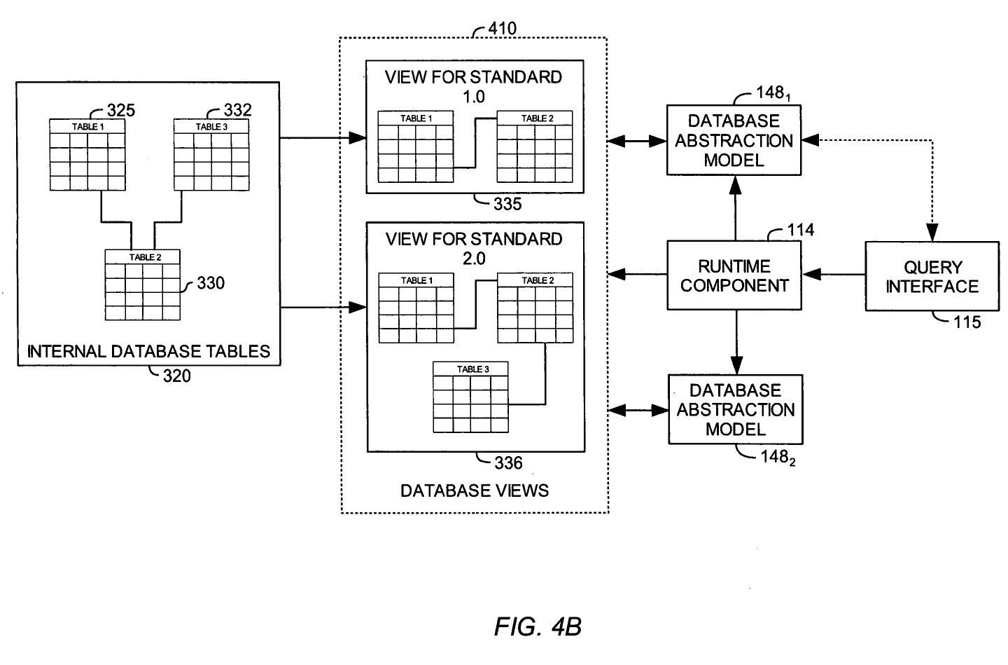

FIGS. 4A-4B are functional block diagrams further illustrating database tables 320 accessed using database views 335 and 336, according to one embodiment of the invention. Database views 410 stores one or more database views of the database tables 320. For the initial version of the standard (i.e., for MageML 1.0), database tables 320 includes table 1 (325) and table 2 (330). The other elements of the query environment include previously described database abstraction model, 148 runtime component 114 and query interface 115. After a new version of the standard is released, the database tables 320 are updated to reflect additions to the standard.

For example, FIG. 4B illustrates database tables 320 with table 1 (325) and table 2 (330), configured to store data organized according to an initial version of a standard. In FIG. 4B, database tables 320 also include table 3 (332) configured to store additional data according to a subsequent version of the standard. In addition, database views 410 includes a database view for the prior version of the standard (view 335) and a database view for the subsequent version of the standard (view 336). FIG. 4B also illustrates database abstraction model 148₁ and 148₂. In one embodiment, each database abstraction model 148 includes all of the logical fields needed to provide a query model for a specific version of the standard. This allows a user interacting with query interface 115 to compose a query based on either database view 335 or database view 336. Accordingly, a query may be executed against data organized according to either the prior or the subsequent version of the standard. Further, if subsequent additional modifications or versions of the standard are adopted, additional database views may be added to database views 410.

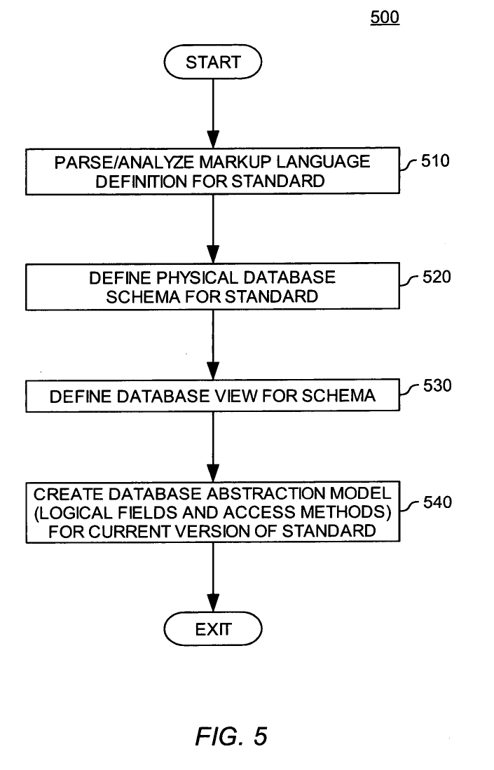

FIG. 5 is a flow chart illustrating a method 500 for configuring a database to store data according to an initial version of a standard, according to one embodiment of the invention. At step 510, a language definition for a standard, such as a markup language like MageML, is analyzed. At step 520, a physical database schema is defined that is organized according to the standard. For example, the schema may be used to define database tables 320.

At step 530, once the database tables 320 are created, a view is defined that exposes the database tables 320. Physical queries may then be executed against the database view to query, search, and retrieve data. Thus, in one embodiment runtime component 114 may be configured to generate a resolved query of a database view in response to receiving an abstract query composed by a user according to database abstraction model 148. Accordingly, at step 540, logical fields are defined with access methods that map to the columns of the database view.

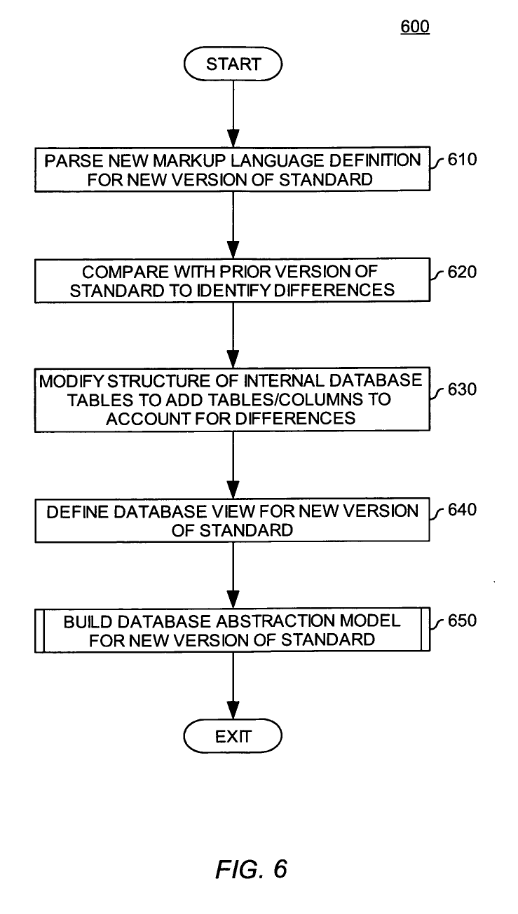

FIG. 6 is a flow chart illustrating a method for updating the database created using the method of FIG. 5, according to one embodiment of the invention. At step 610, a subsequent version of a standard for a markup language definition is analyzed (e.g., parsed). Thus, at step 610, differences between the prior version and the subsequent version are identified. Accordingly, at step 620, the subsequent version is compared with the prior version to identify changes between the prior and subsequent versions. At step 630 the schema of database tables 320 is updated to reflect additions to the standard. For example, this may include both adding additional columns to tables of database 320 as well as adding entirely new tables to database 320. Note however, that by restricting the modifications to additions to existing tables and adding new tables, the current data of the database is left undisturbed, and accordingly queries based on the view may continue to be executed. For example, a user may compose a query according to dam 148₁ and query interface 115. In one embodiment, query interface 115 may allow a user to specify the version of a standard to use for a given query. Doing so allows the interface to present the logical fields appropriate to a user based on the selection.

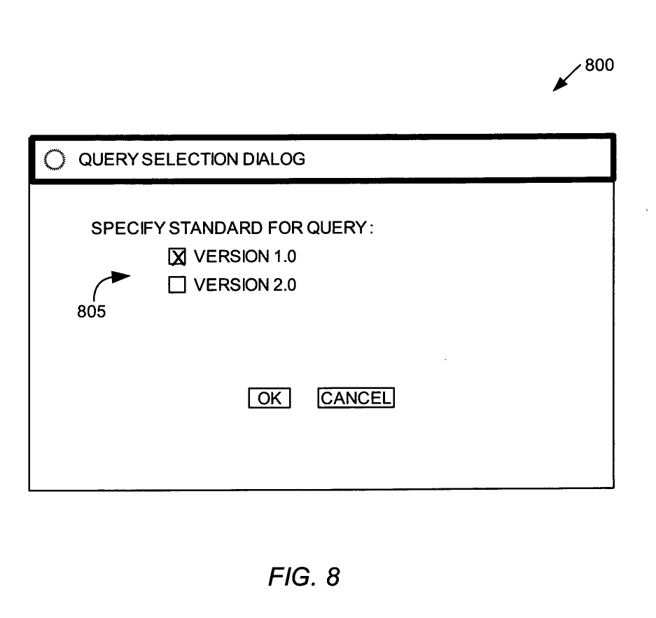

For example, FIG. 8 illustrates an exemplary graphical user interface screen configured with checkboxes 805 that are used to specify which version of a data model standard to use to compose and execute a query. As illustrated, the checkboxes 805 are set to use version 1.0 of a standard, such as MageML.

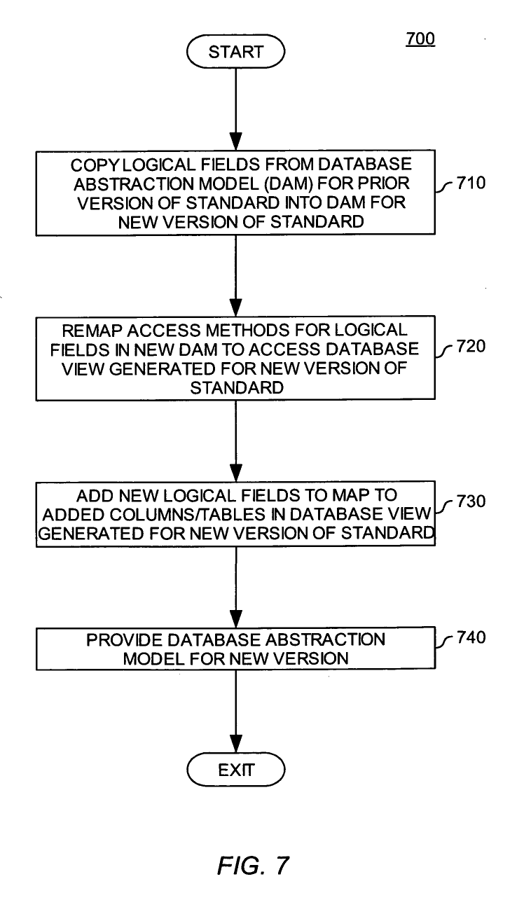

Retuning to the method illustrated in FIG. 6, at step 640, a database view corresponding to the new version of the standard is created. For example, the database view 336 is added to database views 410. This allows for co-existing views of the standards to remain simultaneously available for searching and querying. Subsequently, queries may be composed and executed to retrieve data according to either the prior version or the subsequent version of the standard. As further illustrated in FIG. 7, at step 650, a database abstraction model may be built for the new version of the standard.

FIG. 7 is a flow chart illustrating a method for defining a database abstraction model configured to access data using one of multiple, co-existing versions of a standard, according to one embodiment of the invention. At step 710 the logical fields created for the database abstraction model 148₁ (i.e., the abstraction model that maps to the prior version) are copied into the database abstraction model 148₂ created for the new version (i.e., the database abstraction model created for the subsequent version). At step 720, the access methods for the logical fields copied into database abstraction model 1482 are modified to refer to the database view created for the new version of the standard (e.g., database 336 illustrated in FIG. 4B). At step 730, logical fields corresponding to the additional columns to tables of database 320 added to store data for the new version of the standard are defined. Once completed, at step 740, the database abstraction model 148₂ created for the new version of the standard may be utilized for the querying, searching, and retrieval of data from database 320.

At this point, database tables 332 may be used for shredding, storing, searching, and querying data organized according to either version of the standard. Furthermore, as additional changes are made to the standard, additional views (and a corresponding database abstraction model 148) may be created without disrupting the existing functionality. Instead the system is modified to allow data processing using co-existing versions of a data model standard.

While the foregoing is directed to embodiments of the present invention, other and further embodiments of the invention may be devised without departing from the basic scope thereof, and the scope thereof is determined by the claims that follow.

What is claimed is:

1. A computer-implemented method of managing access to data stored in a database, wherein the database is organized according to an initial version of a data model standard, comprising:
comparing a subsequent version of the standard with the initial version of the standard;
modifying a schema of the database to reflect changes identified by the comparison; and
defining a first logical representation that exposes the data organized according to the initial version of the standard and a second logical representation that exposes data organized according to the subsequent version of the standard.

2. The method of claim 1, wherein the first logical representation and second logical representation comprise database views and the database comprises a relational database.

3. The method of claim 2, further comprising, providing a first and a second database abstraction model each database abstraction model defining a plurality of logical field definitions, each logical field definition comprising a logical field name and a reference to an access method selected from at least two different access method types; wherein each of the different access methods types defines a mapping from the logical field to one of the database views.

4. The method of claim 1, wherein modifying the schema of the database comprises at least one of adding additional columns to existing tables of the database schema to reflect changes identified by the comparison, and adding additional tables to the database schema to reflect changes identified by the comparison.

5. The method of claim 1, wherein the database is populated by shredding a plurality of markup language documents that represent data using either the initial version of the standard or the subsequent version of the standard.

6. The method of claim 1, wherein the data model standard comprises a markup language for describing the data.

7. The method of claim 5, wherein the markup language is defined using XML.

8. A computer-readable medium containing a program which when executed by a processor, performs the method of claim 1.

9. A method for providing access to data represented using multiple versions of a data model standard, comprising:
providing a relational database schema, with tables and columns available to store data organized according to both an initial version of the standard and a subsequent version of the standard;
creating a first and a second database view, each exposing a collection of tables and columns of the database schema corresponding to the initial version and subsequent versions of the standard, respectively;
defining a first and a second database abstraction model each database abstraction model defining a plurality of logical field definitions, each logical field definition comprising a logical field name and a reference to an access method selected from at least two different access method types; wherein each of the different access methods types defines a mapping from the logical field to one of the database views.

10. The method of claim 9, further comprising providing a query interface configured to allow users to select the version of the data model standard to execute a query.

11. The method of claim 9, wherein a relational database, organized according to the relational database schema, is populated by shredding a plurality of markup language documents that representing data using either the initial version of the standard or the subsequent version of the standard.

12. The method of claim 9, wherein the data model standard comprises a markup language for describing the data.

13. The method of claim 12, wherein the markup language is defined using XML.

14. The method of claim 9, defining a first and second database abstraction model, comprises:
copying the logical field definitions of the first database abstraction model created for the initial version of the standard to the second database abstraction model created for the subsequent version of the standard;
remapping the access methods of the logical fields in the second database abstraction model to map to the database view created for the subsequent version of the standard;
adding additional logical field definitions to map to columns in the database created during the modifying step.

15. A computer-readable medium containing a program which when executed by a processor, performs the method of claim 9.

16. A system, for managing data organized according to at least two different versions of a data model standard, comprising:
a computer database with tables and columns available to store data organized according to both an initial version of the standard and a subsequent version of the standard;
a first and second database view, each exposing a collection of tables and columns of a database schema corresponding to the initial version and subsequent versions of the standard, respectively;
a first and a second database abstraction model each database abstraction model defining a plurality of logical field definitions, each logical field definition comprising a logical field name and a reference to an access method selected from at least two different access method types; wherein each of the different access methods types defines a mapping from the logical field to one of the database views; and wherein the first and second database abstraction models allow users to compose queries via a query interface.

17. The system of claim 15, wherein a relational database, organized according to the database schema, is populated by shredding a plurality of markup language documents that representing data using either the initial version of the standard or the subsequent version of the standard.

18. The system of claim 15, wherein the data model standard comprises a markup language for describing the data.

19. The system of claim 15, wherein the markup language is defined using XML.

20. The system of claim 15, further comprising a query interface configured to allow users to select version of the data model standard to execute a query.
